(19) United States
(12) Patent Application Publication
(10) Pub. No.: US 2019/0313588 A1
(43) Pub. Date: Oct. 17, 2019

(54) AIRFLOW-CONTROLLED GROWING PLATFORM SYSTEM AND METHODS OF USE RELATED THERETO

(71) Applicant: Harvest Air, LLC, Dallas, TX (US)

(72) Inventor: John Zimmerman, Dallas, TX (US)

(21) Appl. No.: 16/381,558

(22) Filed: Apr. 11, 2019

Related U.S. Application Data
(60) Provisional application No. 62/656,198, filed on Apr. 11, 2018.

(51) Int. Cl. A01G 9/24; F24F 11/74; F24F 13/02

(52) U.S. Cl. CPC A01G 9/246; F24F 13/02; F24F 11/74

(57) ABSTRACT

System(s), component(s), and/or method(s) that provide for the regulated and controlled laminar flow of air such that the air flow uniformly contacts a plurality of plants to thereby optimize the conditions for the proliferation and growth of each plant of the plurality of plants

### CROSS REFERENCE TO RELATED APPLICATIONS

This application claims the benefit under 35 USC § 119(e) of provisional application U.S. Ser. No. 62/656,198 filed Apr. 11, 2018. The entire contents of the above-referenced application are expressly incorporated herein by reference.

### STATEMENT REGARDING FEDERALLY SPONSORED RESEARCH OR DEVELOPMENT

Not Applicable.

### TECHNICAL FIELD

The presently disclosed and/or claimed inventive concept(s) relate to system(s), component(s), kit(s), and method(s) for providing optimized and/or consistent growing conditions for botanical specimens, including, but not limited to, plants. More specifically, the presently disclosed and/or claimed inventive concept(s) relate to non-limiting embodiments of a system (and components thereof) and method(s) for accurately controlling the airflow conditions in, on, to, about, and/or around plants (such as, by way of example only, cannabis plants) to thereby optimize the growth of and/or growing conditions related to such plants.

### BACKGROUND

The botanical industry is an ever-increasing economic driver in both domestic and international markets. For instance, in the United States, the revenue generated from the sale of legal medicinal and/or recreational cannabis amounted to $9 billion in 2017 alone, with the future revenue estimates exponentially trending upward. It is estimated that the revenue from the sale of legal cannabis just in the United States will rise to $11 billion in 2018 and to $21 billion by 2021.

Current systems and methods do not provide uniform climatic (and/or environmental) factors and/or conditions to optimize the proliferation and growth of various species of plants, including, for instance, cannabis plants. Such climatic factors and/or conditions include, but are not limited to, rainfall/water, light, temperature, relative humidity, and/or air flow/wind. Variations in these climatic factors and/or conditions directly correlate to and affect processes responsible for plant proliferation and growth, including, but not limited to, photosynthesis, transpiration, and/or respiration processes. Of these climatic factors and/or conditions, the flow of air interfacing with a plant(s) is of critical importance, as such air flow can affect the water content temperature, and/or relative humidity of the particular plant(s), thereby greatly impacting the proliferation and growth of such plant(s). Non-uniform/uncontrolled air flow can result in significant variation in the growth of the plants, with some plants growing rapidly due to such plants obtaining the benefits of the air flow, while other plants proliferate at a much slower rate due to inadequate air flow exposure. In some cases, inadequate and/or uncontrolled air flow can actually result in the death of such plants.

Accordingly, there is a need for system(s), component(s), and/or method(s) that provide for the regulated and controlled flow of air such that the air flow uniformly contacts a plurality of plants to thereby optimize the conditions for the proliferation and growth of each plant of the plurality of plants. It is to such system(s), component(s), and/or method(s) that the presently disclosed and/or claimed inventive concept(s) are directed.

### BRIEF DESCRIPTION OF THE DRAWINGS

FIG. 1 illustrates a non-limiting embodiment of a growing platform system constructed in accordance with the presently disclosed and/or claimed inventive concept(s).

FIG. 2 illustrates a non-limiting embodiment of a growing platform shown in FIG. 1 constructed in accordance with the presently disclosed and/or claimed inventive concept(s).

FIG. 3 illustrates an additional non-limiting embodiment of a growing platform system constructed in accordance with the presently disclosed and/or claimed inventive concept(s)

FIG. 4 illustrates an additional non-limiting embodiment of a growing platform system constructed in accordance with the presently disclosed and/or claimed inventive concept(s).

### DETAILED DESCRIPTION

Before explaining at least one embodiment of the present disclosure in detail by way of exemplary language and results, it is to be understood that the present disclosure is not limited in its application to the details of construction and the arrangement of the components set forth in the following description. The present disclosure is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description only and should not be regarded as limiting.

Unless otherwise defined herein, mechanical and technical terms used in connection with the present disclosure shall have the meanings that are commonly understood by those of ordinary skill in the art. Further, unless otherwise required by context, singular terms shall include pluralities and plural terms shall include the singular. The foregoing products and methods are generally produced and performed according to conventional methods well known in the art and as described in various general and more specific references that are cited and discussed throughout the present specification.

All patents, published patent applications, and non-patent publications mentioned in the specification are indicative of the level of skill of those skilled in the art to which this present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles, systems, kits, and/or methods disclosed herein can be made and executed without undue experimentation in light of the present disclosure. While the articles, systems, and methods of the present disclosure have been described in terms of particular embodiments, it will be apparent to those of skill in the art that variations may be applied to the articles, systems, kits, and/or methods and in the steps or in the sequence of steps of the methods described herein without departing from the concept, spirit, and scope of the present disclosure. All such similar substitutions and modifications apparent to those skilled in the art are deemed to be within the spirit, scope, and concept of the present disclosure as defined by the appended claims.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a compound” may refer to one or more compounds, two or more compounds, three or more compounds, four or more compounds, or greater numbers of compounds. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the term “about” is used to indicate that a value includes the inherent variation of error for an apparatus/device/system/kit, the method being employed to determine the value, or the variation that exists among the study subjects. For example, but not by way of limitation, when the term “about” is utilized, the designated value may vary by plus or minus twenty percent or fifteen percent, or twelve percent, or eleven percent, or ten percent, or nine percent, or eight percent or seven percent or six percent, or five percent, or four percent, or three percent, or two percent, or one percent from the specified value, as such variations are appropriate to perform the disclosed methods and as understood by persons having ordinary skill in the art.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “laminar air flow” as used herein refers to air flow in which the air flows in parallel layers with no disruption between the layers. In such laminar air flow, there are no cross-currents running directionally perpendicular to the air flow, nor are there incidents of turbulence, such as, by way of example only, eddies or swirls of air. Laminar air flow, as referred to herein, refers to a non-turbulent flow of the air, the direction of which is substantially parallel to a predetermined surface or direction.

As used herein, the term “plant(s)” shall be understood to be any member of the kingdom Plantae, comprising multicellular organisms that typically produces their own food from inorganic matter by the process of photosynthesis and which have substantially rigid cell walls containing cellulose. By way of example only, plants include, but are not limited to, trees, vegetable and fruit-bearing plants, flowering and non-flowering plants, shrubs, bushes, cacti herbs, grasses, ferns, mosses, and/or weeds. In one non-limiting embodiment of the presently disclosed and/or claimed inventive concept(s), the term plant(s) refers to cannabis plant(s).

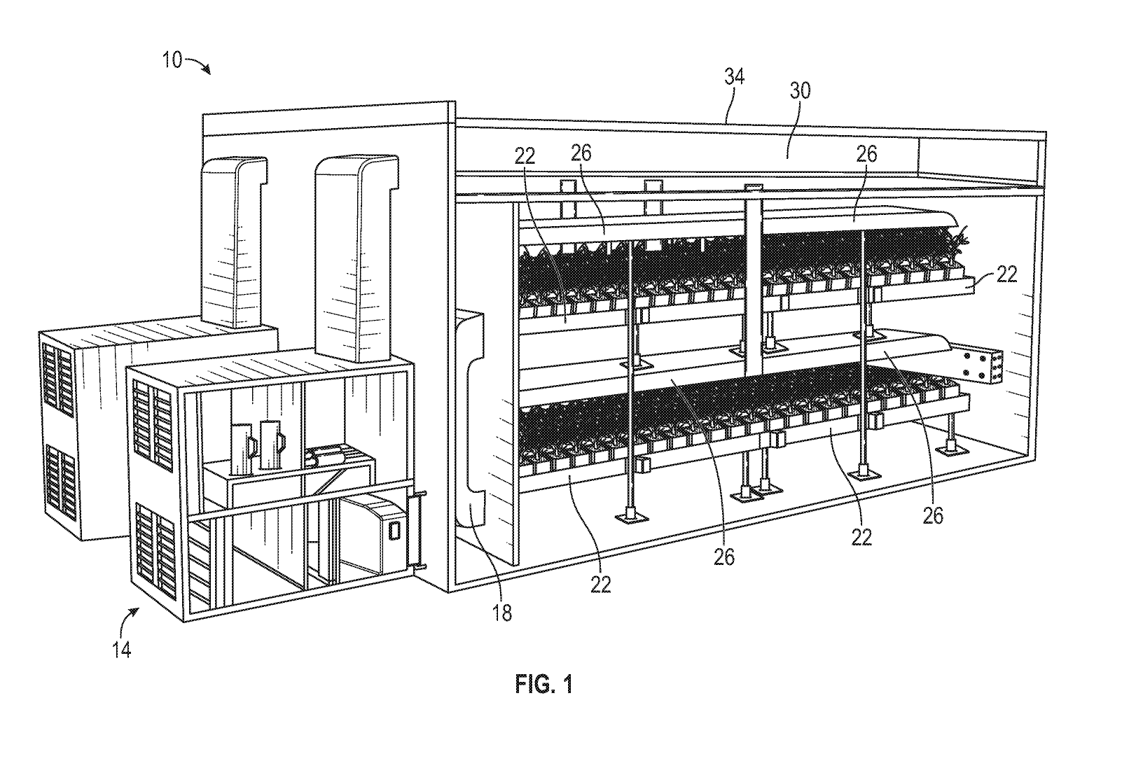

Referring now to the Figures, and, in particular, FIG. 1, shown therein is an illustration of a non-limiting embodiment of a growing platform system 10 constructed in accordance with the presently disclosed and/or claimed inventive concept(s).

As shown in FIG. 1, the growing platform system 10 comprises: (1) at least one air supply source 14; (2) at least one air supply source connector 18 (for instance, by way of a example only, at least one duct and/or duct-like material) that selectively connects the at least one air supply source 14 to the rest of the growing platform system 10 (for instance, to the at least one growing platform 22, as further described herein) and directs the flow of air to the at least one growing platform 22; (3) at least one growing platform 22 configured to receive and hold a plurality of plants and to deliver a continuous and controlled laminar flow of air to such plurality of plants; (4) at least one return air hood 26 which is configured to receive the flow(s) of air emitted from the at least one growing platform 22; (5) at least one return air connector 30 which is configured to receive the air from the at least one return hood 26; and (6) at least one return air duct 34 which is selectively attached to the at least one return air connector 30 such that the air received from the at least one return air connector 30 flows directionally through the at least one return duct 34 back to the at least one air supply source 14 thereby forming the semi-closed, growing platform system 10.

In certain non-limiting embodiments, the at least one air supply source 14 generates a conditioned flow of air for use in the growing platform system 10. A conditioned flow of air is a term commonly known in the art meant to describe a flow(s) of air that is, by way of example only, cooled, heated, filtered, and/or dehumidified. Accordingly, while not shown in FIG. 1, the growing platform system 10 may additionally comprise at least one plenum (not numbered) which is, in one non-limiting embodiment of the presently disclosed and/or claimed inventive concept(s), attached to an outlet of the at least one air supply source 14 to thereby deliver conditioned air flow(s) in, to, and through the growing platform system 10. The at least one air supply source 14 may comprise or consist of at least one single, dedicated heating, ventilation, and air conditioning (HVAC) unit or system, or at least one central HVAC unit or system, for instance, a central HVAC unit or system responsible for providing conditioned air flow(s) to a building or dwelling.

In one non-limiting embodiment, the at least one air supply source connector 18 selectively connects the at least one air supply source 14 to the at least one plenum (not shown) or to the at least one growing platform(s) 22. In one embodiment, the at least one air supply source connector 18 is formed of flexible hosing, duct, and/or duct-like material (which may or may not be insulated) which allows for the selective attachment of the at least one air supply source connector 18 to the at least one growing platform(s) 22 (and/or plenum). The selective attachment allows for additional growing platforms 22 to be selectively connected or disconnected from the growing platform system 10. The at least one air supply source connector 18 may comprise multiple flexible duct components, each of which connects the at least one air supply source connector 18 to each of the at least one growing platform(s) 22. However, a person having ordinary skill in the art should readily appreciate that the at least one air supply source connector 18 can be formed of any material and be of any configuration capable of accomplishing the presently disclosed and/or claimed inventive concept(s). In addition, the at least one air supply source connector 18 may be located at any position with respect to the at least one growing platform(s) 22 in order to direct the flow(s) of air from the at least one air supply source 14 to to the at least one growing platform(s) 22, including, without limitation, at positions, above, below, on the side of, and/or adjacent to the at least one growing platform(s) 22. In one non-limiting embodiment, the at least one air supply source connector 18 is located on the top of the growing platform system 10.

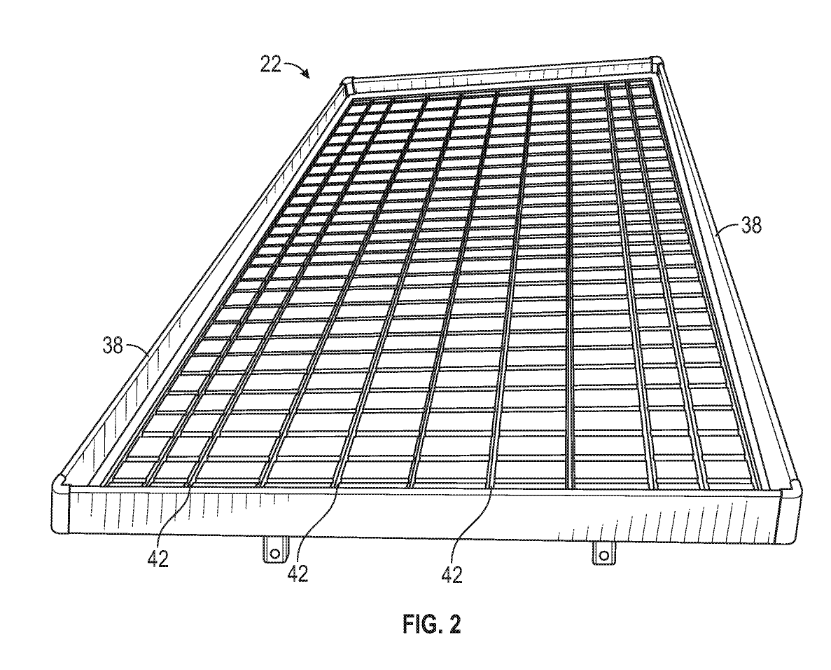

As shown in FIG. 1 (and as further illustrated in FIG. 2), the at least one growing platform(s) 22 is/are configured to receive and hold a plurality of plants and to deliver continuous and controlled laminar air flow, such as, by way of example only, a controlled laminar air flow, to such plurality of plants to thereby optimize and/or to provide consistency to the growing conditions associated with each plant of the plurality of plants. The growing platform system 10 may comprise any number of growing platform(s) 22 that accomplishes the presently disclosed and/or claimed inventive concept(s), including, without limitation, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or greater than or equal to 100 growing platform(s) 22. Each of the growing platform(s) 22 may be of any configuration, dimension, or shape capable of accomplishing the presently disclosed and/or claimed inventive concept(s). For instance, by way of example, each of the growing platform(s) 22 may be the same, different, or combination of same and different shapes and sizes in order to accommodate the same or different species of plants. Such shapes of the plurality of growing platform(s) 22 include, but are not limited to, circular, ovular, triangular, square, rectangular, trapezoidal, pentagonal, hexagonal, heptagonal, octagonal, nonagonal, decagonal, polygonal, and/or any combinations thereof.

The plurality of growing platform(s) 22 may be sized such that one or more of the growing platform(s) 22 receive and hold the same, different, or combinations of same and different amounts of plants in each of the growing platform(s) 22. In one non-limiting embodiment the plurality of growing platform(s) 22 are constructed of rigid and/or semi-rigid material(s) so as to avoid the warping, clogging, and/or deformation of the plurality of growing platform(s) 22 upon its/their exposure to air flow and receipt of the plant(s). Suitable materials for constructing the plurality of growing platform(s) 22 include, without limitation, synthetic and/or naturally-occurring or derived polymers (both organic and/or inorganic), such as, by way of example only, thermoplastic polymer(s), thermoset polymer(s), elastomer(s), and/or synthetic fiber(s) such as low-density polyethylene, high density polyethylene, polystyrene, polyvinylchloride, styrene butadiene, polyacrylics, polyvinyl acetate, and combinations thereof. In addition, the plurality of growing platform(s) 22 may be oriented in any manner within the growing platform system 10 capable of accomplishing the presently disclosed and/or claimed inventive concept(s), including, without limitation, single-tier and/or multi-tiered orientations.

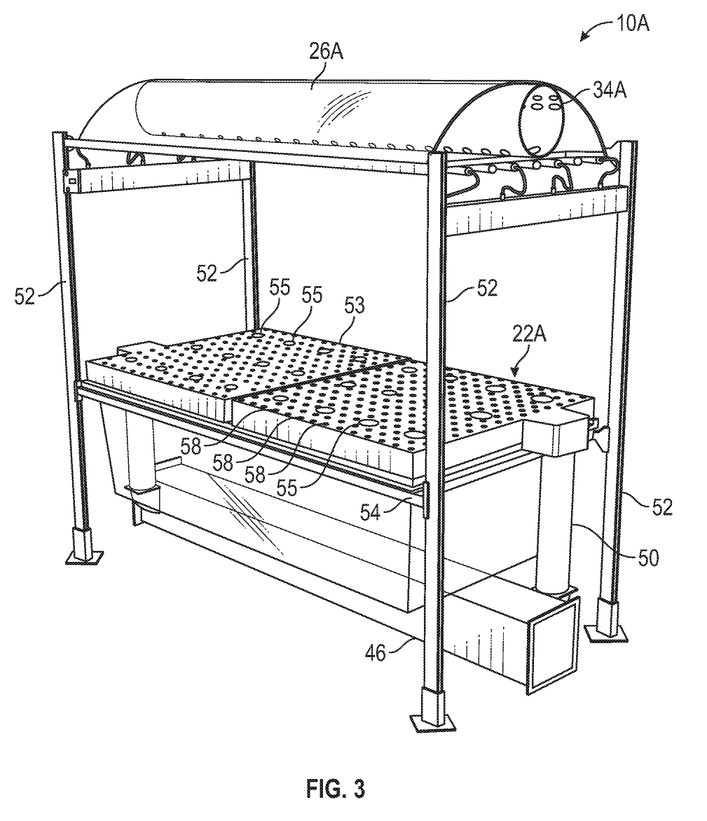

In one non-limiting embodiment, the plurality of growing platform(s) 22 are connected to at least one air supply source 14 via the at least one air supply source connector 18. The plurality of growing platform(s) 22 are configured such that the air flow delivered via the at least air supply source connector 18 to and around each plant disposed in the growing platform(s) 22 is substantially laminar in nature. Such laminar air flow can be in any direction, i.e., from a bottom source to a top return, from a top source to a bottom return, from a left source to a right return, or from a right source to a left return. This laminar air flow provides continuous and controlled air contact with each of the plants thereby allowing for optimal proliferation and growth conditions for each plant. Moreover, the laminar flow of air can be integrated into and be emitted from, by way of example only, horizontal rails/members, vertical rails/members, or a flat, perforated plate/surface or lid—all of which may form structural components of the plurality of growing platform(s) 22 and which may be located above, below, or to the side of the plants disposed within the plurality of growing platforms 22. Additional description of the growing platform(s) is described hereinbelow with respect to FIGS. 2 and 3.

As shown in FIG. 1, in one non-limiting embodiment, the growing platform system 10 comprises at least one return air hood 26 wherein the at least one air hood 26 is selectively or permanently attached to at last one return air connector 30, the at least one return air connector 30 being additionally selectively or permanently connected to at least one return air duct 34. The at least one return air hood 26 is, in one non-limiting embodiment positioned substantially across from and parallel to the at least one growing platform(s) 22 such that the laminar air flow emitted from the at least one growing platform(s) 22 is easily received by and in the at least one return air hood 26. Once received by and within the at least one return air hood 26, the air is transported and (if desired) recycled to the at least one air supply source 14 via the at least one return air connector 30 and subsequently via transport from the at least one return air duct 34. The at least one return air duct 34 may be selectively or permanently attached to at least one plenum (not shown), the at least one air supply source 14, or the at least one return air duct 34 may include a plurality of vents (not shown) for the dissipation and removal of laminar air flow from the growing platform system 10. The return air connection 30 and/or the return air duct 34 can be formed of one or more tubular member having any desired cross-sectional shape, such as rectangular, circular or combinations thereof.

Referring now to FIG. 2, shown therein is an illustration of a non-limiting embodiment of a growing platform(s) 22 depicted in FIG. 1 constructed in accordance with the presently disclosed and/or claimed inventive concept(s).

For purposes of brevity, the description pertaining to the plurality of growing platform(s) 22 with respect to FIG. 1 is deemed fully relevant to the growing platform(s) 22 of FIG. 2 and, as such, will not be repeated herein. Accordingly, only those features of the growing platform(s) 22 not previously discussed or not readily viewed with respect to FIG. 1 are further discussed hereinbelow.

As shown in FIG. 2, the growing platform(s) 22 comprises at least one air source supply duct 38 which receives the flow of air from the at least one air supply source connection 18. Once received by the at least one air source supply duct 38, the air flow then travels through a plenum 40 (shown in phantom) which supplies the air at a predetermined velocity through a plurality of growing platform air channels 42 where the air flow is emitted from the plurality of growing platform air channels 42 in a substantially laminar manner. The velocity of the air will slow rapidly upon the air exiting the air channels 42. The growing platforms 22 include a growing surface 43 adapted to receive and support one or more of the plants. The air channels 42, in the non-limiting embodiments shown in FIG. 2, extend across the growing surface 43 from substantially one end to substantially an opposite end, and from substantially one side to substantially an opposite side in a grid-like pattern. The pattern of the air channels 42 can be configured in patterns other than a grid-like pattern in other embodiments. The predetermined velocity is preferably low enough to not introduce turbulence into the air flow (e.g., thus allowing for the laminar flow emission(s) from the plurality of growing platform air channels 42), or negatively interfere with growing the plants. The predetermined velocity of the air flow, upon exiting the air channels 42 may depend upon the type of plants to be grown on the growing platform. Such predetermined velocities can range from about 0.1 to about 150 feet per second, or from about 0.5 to about 145 feet per second, or from about 1 to about 140 feet per second, or from about 5 to about 135 feet per second, or from about 10 to about 125 feet per second, or from about 15 to about 120 feet per second, or from about 20 to about 115 feet per second, or from about 25 to about 110 feet per second, or from about 30 to about 105 feet per second, or from about 35 to about 100 feet per second, or from 40 to about 95 feet per second, or from about 45 to about 90 feet per second, or from about 50 to about 85 feet per second, or from about 55 to about 80 feet per second, or from about 60 to about 75 feet per second or from about 65 to about 70 feet per second. In one non-limiting embodiment, the predetermined velocity is any velocity less than or equal to about 150 feet per second.

Referring now to FIG. 3, shown therein is an additional non-limiting embodiment of a growing platform system 10A constructed in accordance with the presently disclosed and/or claimed inventive concept(s).

While FIG. 3 depicts the growing platform system 10A as comprising a single growing platform(s) 22A, a person having ordinary skill in the art should readily appreciate that the growing platform system 10A can comprise any number of growing platform(s) 22A which are oriented and configured in any manner capable of accomplishing the presently disclosed and/or claimed inventive concept(s), for instance, by way of example, single-tier and/or multi-tier orientations.

In one non-limiting embodiment, the growing platform system 10A comprises: (1) at least one growing platform(s) 22A having a growing surface 43A perforated or otherwise formed with air channels 42A; (2) at least one return air hood 26A which is configured to receive the flow(s) of air emitted from the at least one growing platform(s) 22A; (3) at least one return air duct 34A selectively or permanently attached to the at least one return air hood 26A to thereby return the received air flows back to at least one air supply source (not shown in FIG. 3); (4) at least one air supply duct 46 that supplies flow(s) of air to the growing platform system 10A from the at least one air supply source (not shown); (5) at least one air supply source connector 50 that connects the at least one air supply duct 46 to the growing platform system 10A (for instance, via connection to the at least one growing platform(s) 22A); and (6) at least one growing platform system support member(s) 52 (four being shown by way of example) that extend substantially vertically from and perpendicular to a floor to thereby provide a frame for the growing platform system 10A.

Descriptions with respect to the at least one growing platform(s) 22, at least one return air hood(s) 26, and at least one return air duct 34 of the growing platform system 10 are deemed relevant to the at least one growing platform(s) 22A, at least one return air hood(s) 26A, and at least one return air duct 34A, respectively, of the growing platform system 10A. Accordingly, no further description is deemed necessary with respect to these components of the growing platform system 10A. In addition, the at least one air supply duct 46, at least one air supply source connector 50, and the at least one growing platform system support member(s) 52 function and are constructed in accordance with materials and manners commonly known in the art and no additional description is deemed necessary with respect to these components of the growing platform system 10A.

As shown in FIG. 3, the at least one growing platform(s) 22A comprises at least one lid 53 which is disposed on or over at least one growing platform container 54 which, in one non-limiting embodiment, may contain a plurality of plants.

The at least one lid 53 comprises at least one plant holder 55. Plant(s) may, in one embodiment, be disposed directly within the at least one plant holder 55. In another non-limiting embodiment, plant(s) are disposed within the at least one growing platform container 54 and positioned in a manner that allows the plant(s) to grow from the at least one growing platform container 54 through the at least one plant holder 55 which provides support for the plant(s) as such plant(s) grow in size. In addition, the at least one lid 53 comprises a plurality of air channels 58 that, as described elsewhere herein, provide a substantially laminar flow(s) of air in, to, about, and around each plant thereby providing uniform conditions (including, without limitation, air flow, temperature, humidity, and carbon dioxide content) to optimize the growth and proliferation of each plant(s). The plurality of air channels 58 dissipate and emit a substantially laminar flow(s) of air after receiving such air from the at least one air supply duct 46 via, for instance, the at least one growing platform air supply connector 50.

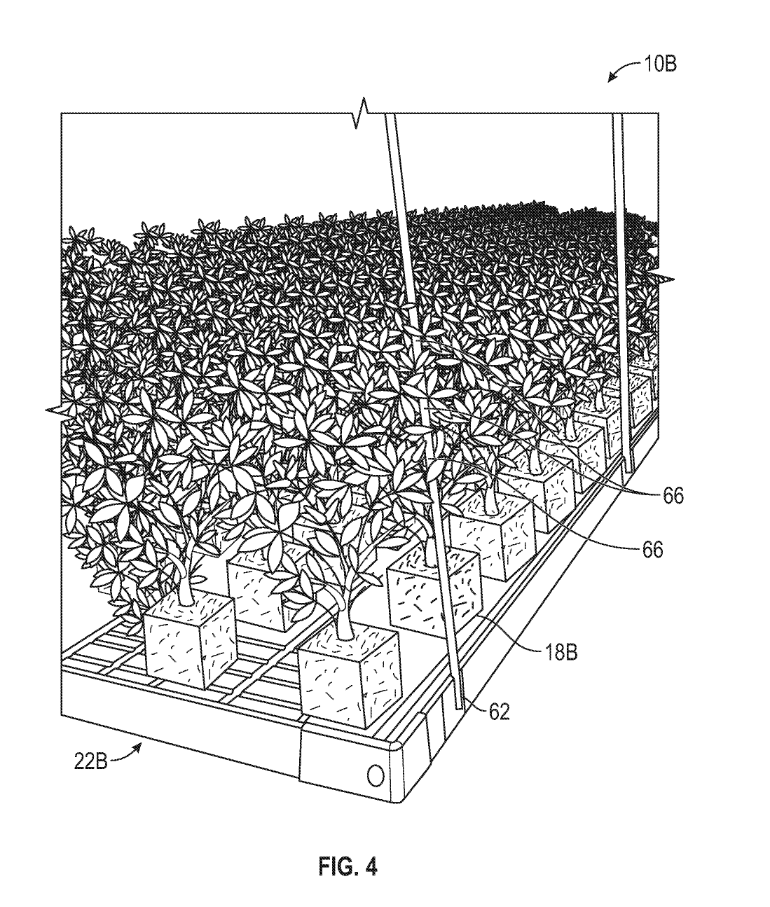

Referring now to FIG. 4, shown therein is an additional non-limiting embodiment of a growing platform system 10B constructed in accordance with the presently disclosed and/or claimed inventive concept(s).

Descriptions with respect to the at least one growing platform(s) 22 and the at least one air supply source connector 18 are deemed relevant to the at least one growing platforms 22B and the at one air supply source connector 18A, respectively, of the growing platform system 10B. Accordingly, for purposes of brevity, such descriptions will not be repeated herein.

The growing platform system 10B comprises a plurality of vertical air flow members 62, the plurality of vertical air flow members 62 being selectively or permanently connected to the at least one air supply source connector 18A and extending vertically from and substantially perpendicular to at least one growing platform(s) 22B. The vertical air flow members 62 comprise a plurality of openings 66 that emit a substantially laminar flow(s) of air across the plants disposed in or on the at least one growing platform(s) 22B, the substantially laminar air flow being directed substantially parallel to the at least one growing platform(s) 22B.

The vertical air flow members 62 may be constructed of any material(s) commonly known in the art, including, without limitation, stainless steel. The vertical air flow members 62 may also be telescoping whereby the vertical air flow members 62 may be extended or shortened to accommodate the size of the plants. In addition, the vertical air flow members 62 may serve as support(s) for the covering of the plants, for instance, by way of example only, as supports for a netting material used to cover the plants.

Certain non-limiting embodiments of the presently disclosed and/or claimed inventive concept(s) include, but are not limited to, the following:

A growing platform system for the optimization of growing conditions associated with a plurality of plants, comprising: at least one air supply source; at least one air supply duct selectively attached to the at least one air supply source; at least one return duct selectively attached to the at least one air supply source; and at least one growing platform, the at least one growing platform being connected to the at least one air supply source via the at least one of the air supply duct and the return air duct, the at least one growing platform comprising a growing surface with a plurality of openings communicating with the at least one air supply duct and the return air duct to deliver a substantially continuous and laminar flow of air to a plurality of plants, the at least one growing platform being disposed between the at least one air supply duct and the at least one return duct.

The growing platform system, wherein the at least one growing platform is substantially rectangular in shape.

The growing platform system, wherein in the plurality of plants is selected from the group consisting of trees, vegetable and fruit-bearing plants, flowering and non-flowering plants, shrubs, bushes, cacti herbs, grasses, ferns, mosses, weeds, and combinations thereof.

The growing platform system, wherein the flowering plants are cannabis plants.

The growing platform system, wherein the plurality of openings comprise at least one air channel disposed in or on at least one surface of the at least one growing platform.

The growing platform system, wherein the at least one air supply source is selected from the group consisting of a single, dedicated HVAC unit or system, at least one central HVAC unit or system responsible for providing conditioned air flow(s) to a building or dwelling, and combinations thereof.

The growing platform system, wherein the flow of air is emitted from the plurality of openings at a velocity of less than 150 feet per second.

The growing platform system, further comprising at least one plenum, the at least one plenum being selectively attached to the at least one air supply source and the at least one air supply duct.

A plant growing platform, comprising: a base having a growing surface configured to receive and support one or more plants, the base comprising a plurality of openings through the growing surface for the emission of a substantially continuous and laminar flow of air to a plurality of plants, the base defining a plenum configured to supply air to the openings and an inlet port communicating with the plenum so as to be configured to receive a source of air from at least one air supply source via at least one air supply duct.

The plant growing platform, wherein the plurality of openings comprise at least one air channel disposed in or on at least one surface of the plant growing platform.

The plant growing platform, wherein the at least one air supply source is selected from the group consisting of a single, dedicated HVAC unit or system, at least one central HVAC unit or system responsible for providing conditioned air flow(s) to a building or dwelling, and combinations thereof.

The plant growing platform, wherein the at least one growing platform is substantially rectangular in shape.

The plant growing platform, wherein in the plurality of plants is selected from the group consisting of trees, vegetable and fruit-bearing plants, flowering and non-flowering plants, shrubs, bushes, cacti herbs, grasses, ferns, mosses, weeds, and combinations thereof.

The plant growing platform, wherein the flowering plants are cannabis plants.

A method for optimizing the growing and proliferation conditions of a plurality of plants, the method comprising the steps of: disposing a plurality of plants in or on at least one growing surface of a growing platform of a growing platform system, the growing platform system comprising: at least one air supply source; at least one air supply duct selectively attached to the at least one air supply source; at least one return duct selectively attached to the at least one air supply source; and the at least one growing platform being connected to the at least one air supply source via the at least one air supply duct or the return duct, the at least one growing platform comprising a plurality of openings through the growing surface to deliver a substantially continuous and laminar flow of air to the plurality of plants, the at least one growing platform being disposed between the at least one air supply duct and the at least one return duct; and delivering a continuous and substantially laminar flow of air to the plurality of plants via the growing platform system.

The method, wherein the at least one growing platform is substantially rectangular in shape.

The method, wherein in the plurality of plants is selected from the group consisting of trees, vegetable and fruit-bearing plants, flowering and non-flowering plants, shrubs, bushes, cacti herbs, grasses, ferns, mosses, weeds, and combinations thereof.

The method, wherein the flowering plants are cannabis plants.

The method, wherein the plurality of openings comprise at least one air channel disposed in or on at least one surface of the at least one growing platform.

The method, wherein the at least one air supply source is selected from the group consisting of a single, dedicated HVAC unit or system, at least one central HVAC unit or system responsible for providing conditioned air flow(s) to a building or dwelling, and combinations thereof.

Thus, in accordance with the presently disclosed and/or claimed inventive concept(s), there have been provided systems and components, as well as methods of producing and using the same, which fully satisfy the objectives and advantages set forth hereinabove. Although the present disclosure has been described in conjunction with the specific drawings, experimentation, results, and language set forth hereinabove, it is evident that many alternatives, modifications, and variations will be apparent to those skilled in the art. Accordingly, it is intended to embrace all such alternatives, modifications, and variations that fall within the spirit and broad scope of the present disclosure.

What is claimed is:

1. A growing platform system for the optimization of growing conditions associated with a plurality of plants, comprising:
at least one air supply source;
at least one air supply duct selectively attached to the at least one air supply source;
at least one return duct selectively attached to the at least one air supply source; and
at least one growing platform, the at least one growing platform being connected to the at least one air supply source via the at least one air supply duct or the return duct, the at least one growing platform comprising a growing surface defining at least one opening to deliver a substantially continuous and laminar flow of air to a plurality of plants, the at least one growing platform being disposed between the at least one air supply duct and the at least one return duct.

2. The growing platform system of claim 1, wherein the at least one growing platform is substantially rectangular in shape.

3. The growing platform system of claim 1, wherein in the plurality of plants is selected from the group consisting of trees, vegetable and fruit-bearing plants flowering and non-flowering plants, shrubs, bushes, cacti herbs, grasses, ferns, mosses, weeds, and combinations thereof.

4. The growing platform system of claim 3, wherein the flowering plants are cannabis plants.

5. The growing platform system of claim 1, wherein the plurality of openings comprise at least one air channel disposed in or on at least one surface of the at least one growing platform.

6. The growing platform system of claim 1, wherein the at least one air supply source is selected from the group consisting of a single, dedicated HVAC unit or system, at least one central HVAC unit or system responsible for providing conditioned air flow(s) to a building or dwelling, and combinations thereof.

7. The growing platform system of claim 1, wherein the flow of air is emitted from the plurality of openings at a velocity of less than 150 feet per second.

8. The growing platform system of claim 1, further comprising at least one plenum, the at least one plenum being selectively attached to the at least one air supply source and the at least one air supply duct.

9. A plant growing platform, comprising:
a base having a growing surface configured to receive and support one or more plant, the base comprising at least one opening through the growing surface and disposed within a growing region of the growing surface for the emission of a substantially continuous and laminar flow of air to a plurality of plants, the base defining a plenum configured to supply air to the opening(s), and an inlet port communicating with the plenum, the inlet port configured to receive a source of air from at least one air supply source via at least one air supply duct.

10. The plant growing platform of claim 9, wherein the at least one opening comprise at least one air channel disposed in or on at least one surface of the plant growing platform.

11. The plant growing platform of claim 9, wherein the at least one air supply source is selected from the group consisting of a single, dedicated HVAC unit or system, at least one central HVAC unit or system responsible for providing conditioned air flow(s) to a building or dwelling and combinations thereof.

12. The plant growing platform of claim 9, wherein the at least one grooving platform is substantially rectangular in shape.

13. The plant growing platform of claim 9, wherein in the plurality of plants is selected from the group consisting of trees, vegetable and fruit-bearing plants, flowering and non-flowering plants, shrubs, bushes, cacti herbs, grasses, ferns, mosses, weeds, and combinations thereof.

14. The plant growing platform of claim 13, wherein the flowering plants are cannabis plants.

15. A method for optimizing the growing and proliferation conditions of a plurality of plants, the method comprising the steps of:
disposing a plurality of plants in or on at least one growing surface of a growing platform of a growing platform system, the growing platform system comprising:
at least one air supply source;
at least one air supply duct selectively attached to the at least one air supply source;
at least one return duct selectively attached to the at least one air supply source; and
the at least one growing platform being connected to the at least one air supply source via the at least one air supply duct or the air return duct, the at least one growing platform comprising a plurality of openings through the growing surface to deliver a substantially continuous and laminar flow of air to the plurality of plants, the at least one growing platform being disposed between the at least one air supply duct and the at least one return duct; and
delivering a continuous and substantially laminar flow of air to the plurality of plants via the growing platform system.

16. The method of claim 15, wherein the at least one growing platform is substantially rectangular in shape.

17. The method of claim 15, wherein in the plurality of plants is selected from the group consisting of trees, vegetable and fruit-bearing plants, flowering and non-flowering plants, shrubs, bushes, cacti herbs, grasses, ferns, mosses, weeds, and combinations thereof.

18. The method of claim 17, wherein the flowering plants are cannabis plants.

19. The method of claim 15, wherein the plurality of openings comprise at least one air channel disposed in or on at least one surface of the at least one growing platform.

20. The method of claim 15, wherein the at least one air supply source is selected from the group consisting of a single, dedicated HVAC unit or system, at least one central HVAC unit or system responsible for providing conditioned air flow(s) to a building or dwelling, and combinations thereof.
